(19) United States
(12) Patent Application Publication
(10) Pub. No.: US 2021/0075000 A1
(43) Pub. Date: Mar. 11, 2021

(54) STRAIN TOLERANT PARTICLE STRUCTURES FOR HIGH ENERGY ANODE MATERIALS AND SYTHESIS METHODS THEREOF

(71) Applicant: 6K Inc., North Andover, MA (US)

(72) Inventors: Richard K. Holman, Wellesley, MA (US); Leah Nation, Cambridge, MA (US)

(21) Appl. No.: 17/011,740

(22) Filed: Sep. 3, 2020

Related U.S. Application Data
(60) Provisional application No. 62/897,071, filed on Sep. 6, 2019.

(51) Int. Cl. H01M 4/134; H01M 4/1395; H01M 4/04; H05H 1/30

(52) U.S. Cl. CPC H01M 4/134; H01M 4/1395; H01M 2004/028; H05H 1/30; H01M 4/0416

(57) ABSTRACT

Disclosed herein are embodiments of strain tolerant particle structures, methods of manufacturing such structures, and precursors to form said structures. In some embodiments, the structures can be formed of a network of nano-scale walls. The structures can be incorporated into powders, which can then be used for any number of applications, such as microwave plasma processing.

### INCORPORATION BY REFERENCE TO ANY PRIORITY APPLICATIONS

The present application claims the benefit under 35 U.S.C. § 119(c) of U.S. Provisional Patent Application No. 62/897,071, filed Sep. 6, 2019, which is incorporated herein by reference in its entirety under 37 C.F.R. § 1.57. Any and all applications for which a foreign or domestic priority claim is identified in the Application Data Sheet as filed with the present application are hereby incorporated by reference under 37 CFR 1.57.

### BACKGROUND

### Field

The present disclosure is generally directed in some embodiments towards powders, structures, precursors, and methods of manufacturing said powders and structures to form strain tolerant materials.

### Description of the Related Art

Alloy-type anode materials, which include Si, SiO, and Sn alloys, have been an area of intense research for over 20 years. An advantage to this class of materials is a large increase in lithium (Li) storage capacity, or simply capacity, over conventional anode materials based on carbon (primarily graphite), as much as 10× in the case of Si compared to typical commercial graphite anodes. However, their adoption as a full replacement for graphite has been impeded by very poor cycle life. Silicon (Si) undergoes a 300% volume increase upon full lithiation, and 300% decrease upon subsequent delithiation. This massive volume cycling results in mechanical damage to the Si particles, which results in material disconnection, fresh surfaces that react with the electrolyte and consume lithium while passivating, and thus capacity loss and impedance growth, in as few as a few cycles in the worst case. As a result, alloy anodes have been limited commercially to blends of very fine alloy particles with graphite, generally at <10% of the total active material. Promising cycle life improvements have been seen by producing nano-structures of alloy anode (e.g. arrays of Si nano rods, etching of second phases to leave behind a nano structured film), but these have been limited to thin film structures and vapor deposition methods, which are neither cost effective nor compatible with existing lithium ion production equipment.

### SUMMARY

Disclosed herein are embodiments of a strain tolerant particle comprising: a plurality of walls surrounding a plurality of voids, the walls being between 10-90% of a total volume of the particle; and Si, Si monoxide, Sn, or Sn oxide; wherein the particle is configured to stay within 50 volume % during lithiation and delithiation.

In some embodiments, the plurality of voids are closed cells. In some embodiments, the plurality of voids are open cells. In some embodiments, the plurality of voids are a mixture of closed cells and open cells. In some embodiments, the plurality of walls are between 20 and 50% of the total volume of the particle. In some embodiments, the plurality of walls have a thickness of between 50 and 150 nm. In some embodiments, the particle is coated with carbon. In some embodiments, the particle is configured to stay within 10 volume % during lithiation and delithiation. In some embodiments, the particle further comprises a transition metal. In some embodiments, the particle comprises polydimethylsiloxane. In some embodiments, the particle comprises diphenylsiloxane.

Also disclosed herein are embodiments of a powder formed from a plurality of the strain tolerant particle. In some embodiments, a D50 of the powder lies between 0.2 and 100 um.

Also disclosed herein are embodiments of an anode formed from the strain tolerant particle. Also disclosed herein is a battery formed from the anode.

Also disclosed herein are embodiments of a method of manufacturing a strain tolerant powder, the method comprising: preparing a precursor material including an Si, Si monoxide, Sn, or Sn oxide material and a component that produces gas; forming droplets from the precursor material; and interacting the droplets in a plasma or plasma exhaust of a microwave plasma torch to produce gases from the component and form a powder of a plurality of particles; wherein the precursor material is configured to prevent gas bubbles formed during synthesis from coalescing and/or escaping; and wherein the particles in the powder are configured to stay within 50 volume % during lithiation and delithiation.

In some embodiments, a viscosity of the precursor material is between 3 and 500 cS. In some embodiments, the plurality of particles includes a carbon coating. In some embodiments, the plurality of particles includes an Al2O3 coating.

Also disclosed herein are embodiments of a strain tolerant particle comprising: a composition comprising: silicon, tin, or a combination of silicon and tin; a transition metal; and silica; and a plurality of walls surrounding a plurality of voids, the walls being between 10-90% of a total volume of the particle; wherein the particle is configured to stay within 50 volume % during lithiation and delithiation.

### BRIEF DESCRIPTION OF THE DRAWINGS

FIGS. 1A-1D illustrate embodiments of a SiO powder with integral porosity and fine SiO wall structure of the “foam” particle morphology produced using 50 cS polydimethoxysilane (silicone oil) in an oxygen rich microwave plasma.

FIG. 2 illustrates an example of a closed cell configuration.

FIG. 3 illustrates an example of an open cell configuration.

FIG. 4 illustrates electrochemical results for the powder of FIG. 1A, showing over 1000 mAh/g first charge capacity.

FIG. 5 illustrates an example embodiment of a method of producing powders according to the present disclosure.

FIG. 6 illustrates an embodiment of a microwave plasma torch that can be used in the production of powders, according to embodiments of the present disclosure.

FIGS. 7A-7B illustrate embodiments of a microwave plasma torch that can be used in the production of powders, according to a side feeding hopper embodiment of the present disclosure.

### DETAILED DESCRIPTION

Disclosed herein are embodiments of methods, powders/particles, structures, and precursors for forming porous strain-tolerant materials, and devices which incorporate said materials. The materials can be powders of porous particle structures for a strain-tolerant alloy-type anode. As disclosed herein, the powder can be formed by processing certain precursors in a plasma torch, such as a microwave plasma torch, or other processing methods. The processing can include feeding the precursors into a microwave plasma torch, a plasma plume of the microwave plasma torch, and/or an exhaust of the microwave plasma torch. The location may vary depending on the type of feedstock used. Further the precursors can be selected based on different requirements. Examples of requirements are aspect ratio, particle size distribution (PSD), chemistry, density, diameter, sphericity, oxygenation, and pore size. In some embodiments, silicone or silica based materials can be used. In some embodiments, a silicon, transition metal, and/or a silica can be used to form a material as discussed herein.

Specifically, disclosed herein are embodiments of micron-scale particle structures composed of a network of nano-scale “walls” of alloy anode-based storage material forming a porous “foam” particle. These particle structures can form a powder, which can be incorporated into the formation of an anode, such as for a battery.

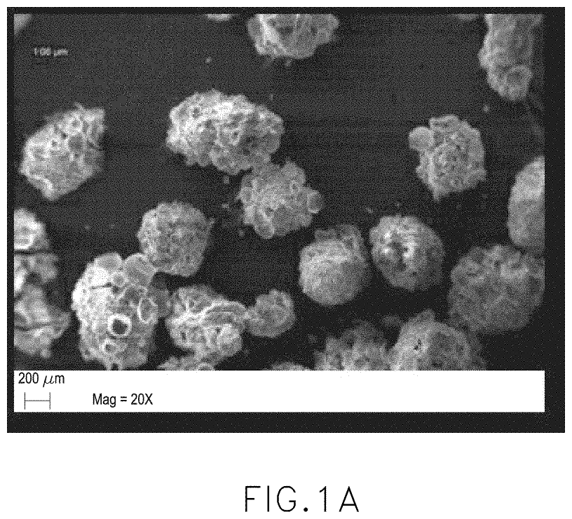

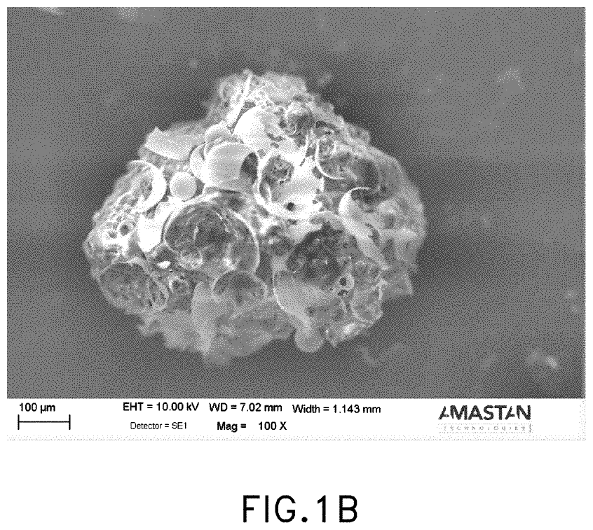

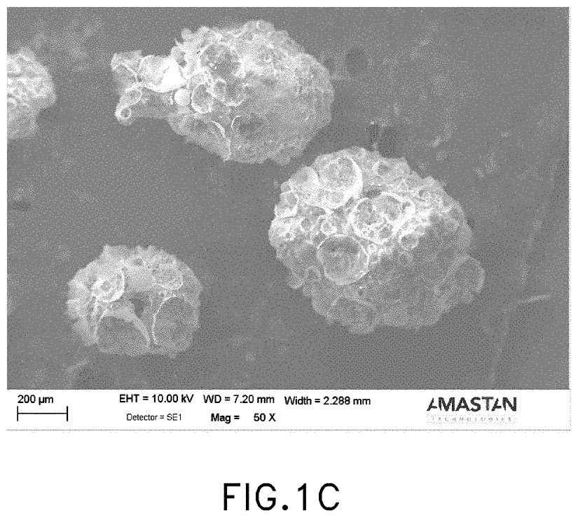

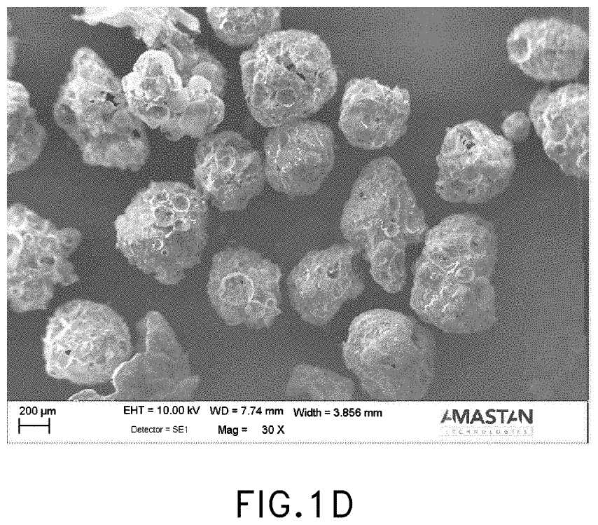

An example of such a structure is shown in FIGS. 1A-1D. As shown, the powder particles are formed by a number of walls surrounding voids within the particles. The walls of the voids, or “bubbles”, making up this foam, have characteristic sizes ranging in the 10's to 100's of nanometers in the narrowest dimension (e.g., “wall thickness”). Thus, these foam particles can be divided into a blend of a solid phase and a gas/void phase. The solid phase can be between 10-90% of the total volume of the particle, leaving the remainder to the voids.

The disclosed particles can advantageously have a size scale which can accommodate the high strains associated with lithiation/delithiation. For example, the void volume within the structure (e.g., the spaces between the walls) can accommodate expansion of the walls without significant damage, and without a large overall particle size change. This is an advantageous characteristic to ensure that the particles in an anode electrode remain in contact with each other and the current collector to maintain electrical continuity. Further, the expansion accommodation allows for the electrochemical device to not have to accommodate huge thickness changes in the electrodes, which has consequences for device size, complexity, thermal management, etc. Additionally, the ability to produce these structures in a powder morphology means the material is not limited to thin film structures and can be used as a drop-in replacement for graphite powders on existing production equipment.

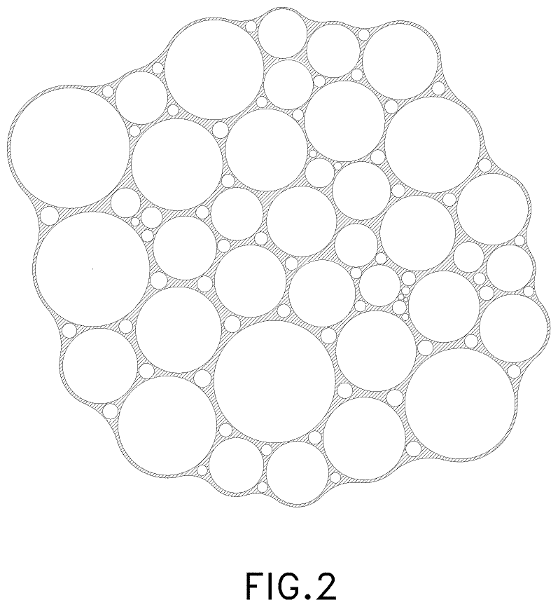

In some embodiments, the foam structure is primarily a closed cell structure as shown in FIG. 2, meaning the voids are not exposed to the surface of each particle. In the electrochemical device, a passivation layer can be formed on all exposed surfaces of the anode material to prevent continuous reaction of the electrolyte with the lithiated storage material. To minimize the capacity loss associated with this necessary passivation, it is advantageous to minimize the amount of exposed surface area. A closed-cell foam structure prevents electrolyte from accessing the internal surfaces of the foam, minimizing the irreversible capacity loss of passivation.

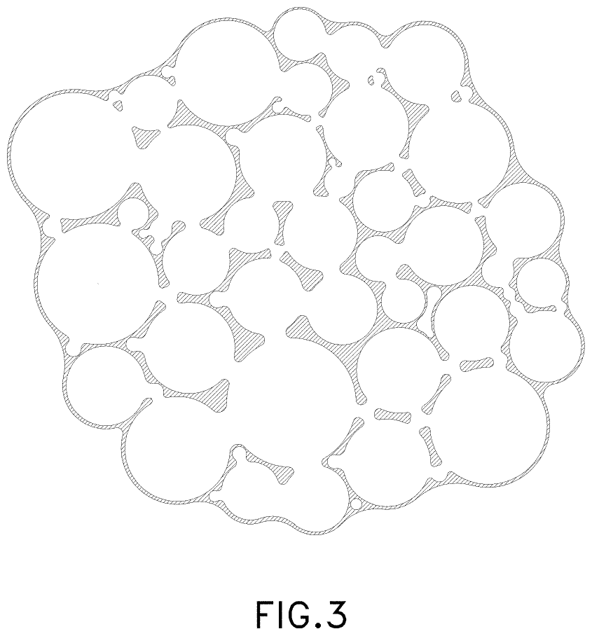

In some embodiments, the foam is composed of an open cell structure as shown in FIG. 3. The open cell structure could allow for coating/filling of the internal surfaces with carbon or another conductive additive, such as a conductive polymer, to improve conductivity, and if it coats the surfaces and/or fills the pores, this can reduce the capacity loss associated with passivation. Other non-conductive surface layers could also be employed to reduce passivation reactions (e.g. aluminum oxide applied via atomic layer deposition, infiltrated from a slurry). Open cells could also improve power by allowing for better access of electrolyte to surfaces and thus better access of lithium for transport, at the expense of capacity loss due to passivation. On the other hand, the open cell structure may be disadvantageous because it allows liquid electrolyte to access all the internal surface area of the foam, where it must react to form a passivation layer, thereby consuming capacity.

In some embodiments, the foam has a mixed open and closed cell structure. This can allow for tradeoffs between power and capacity loss to be adjusted, allowing for tuning.

### Precursors

Disclosed herein are precursor materials, or classes of precursor materials, which can be used in the synthesis of strain-tolerant high energy storage material structures as discussed. The structures can be in powder form, applicable in particular to anode chemistries that undergo large cyclic volume changes during charge and discharge, e.g. Si-based alloys and Si—O, Sn-based alloys. As mentioned, the strain tolerant powders can be composed of a “foam” where the foam's structural component is the storage material; the walls of the foam “cells” have with nano-scale dimensionality in the thickness direction, making them able to withstand the large volume change without structural damage, and the void space accommodates the volume change of the active material (300% or more) without a large change in the overall diameter of the foam particle, which can be advantageous to the design of any device utilizing such high volume change materials. Otherwise, the cell, pack, and/or system design would have to accommodate large cyclic dimensional changes, adding cost, complexity, and space inefficiency. Although certain chemical elements have been described above, it is to be understood that other elements can be utilized as well.

An example precursor for such a material would have the following characteristics: a.) contains the source of the storage material (for example Si and/or Sn based materials); b.) have a component that produces gas during synthesis to provide the pore structure (e.g., OH groups, CH/CH2/CH3 groups, N, NO groups, C, or CO groups); and c.) have the appropriate combination of properties (e.g. viscosity, surface tension) to prevent the gas bubbles formed during synthesis from coalescing and/or escaping, maintaining the fine pore structure desired for a nanoporous micron scale strain tolerant particle. By optimizing the combination of precursor properties, precursor chemistry, reaction environment (e.g. oxidative, neutral, reducing, reactive species, etc.), feed method, and reaction rate (temperature, etc.) a particular size of particle, void dimension, and volume fraction of active in the composite foam structure particles can be dialed in. Although certain precursor elements have been described above, it is to be understood that other elements can be utilized as well.

In some embodiments, the component that produces gas during decomposition of the precursor (e.g., b in the above) acts as a void former. Further, using a somewhat viscous liquid as the precursor can help to keep the voids from coming to the surface or coalescing during the reaction, thus forming the voided foam structure.

Additionally, dopants/modifiers can be added to the disclosed precursors. This can include, for example, boron, phosphorous, nitrogen, and/or a source of carbon.

Advantageous particle sizes may have a D50 which lies between 0.2 and 100 um (or about 0.2 to about 100 um), more preferably 2 and 30 um (or about 2 and about 30 um). In some embodiments, particles may have a D50 up to 200, 300, 400, 500, 600, 700, 800, 900, or 1000 um (or about 200, about 300, about 400, about 500, about 600, about 700, about 800, about 900, or about 1000 um). In some embodiments, a milling operation may be used to bring the particles to a particular size range. Advantageous porosity levels to accommodate strain lie between 10 and 90% (or about 10 and about 90) void space pr between 50 and 80% (or about 50 and about 80). In some embodiments, 67% porosity can correspond to the condition at which the expansion completely fills the available pore space for 300% volume expansion of the active material. In some embodiments, it may also be advantageous to have a carbon source in the precursor to produce in-situ formed carbon on the surface of the storage material to improve conductivity and reduce the reactivity of the exposed surfaces to the electrolyte in the resulting electrochemical storage device (“cell”).

For silicone-anode-based chemistries, a number of materials classes can satisfy for the formation of the voided material, including but not limited to silanes including disilane, trisilane, tetrasilane, pentacycline, hexasilane, cyclosilanes, triethoxyethylsilane, triethoxymethylsilane, n-propyletriethoxysilane, dimethoxysilane/polydimethoxysilane, 1,3,5,7-tetramethyl-1,3,5,7-tetravinylcyclotertrasilosane, amino silanes, silanols including but not limited to trimethylsilanol and diphenylsilanedio, siloxanes and polysiloxanes including but not limited to polydimethylsiloxane, hexamethyldisiloxane octamethylcyclotetrasiloxane, decamethylcyclopentasiloxane, and dodecamethylcyclohexasiloxane, silyl ethers including but not limited to trimethylsilyl ether (TMS), triethylesilyl ether, tert-butyldiphenylsilyl (TBDPS), tert-butyldimethylsilyl (TBS/TBDMS) and triisopropylsilyl (TIPS), silicates including ortho-, meta-, and pyro-silicates, including but not limited to tetramethylorthosilicate (TMOS) and tetraethylortho silicate (TEOS), Silicon halides including but not limited to silicon tetrachloride, silicon tetrabromide, organosilyl halides including but not limited to dimethyldichlorosilane, methyltrichlorosilsilane, and trimethylsilyl chloride, silenes, silylenes, and orthosilicic. Although certain chemistry has been described above, it is to be understood that other chemistry can be utilized as well.

In some embodiments, the precursor used in the processing of a strain tolerant high energy Si-based anode storage material powder can be polydimethylsiloxane, e.g., silicone oil, (C₂H₆OSi)ₙ. Alternative materials can be used as well, such as other siloxanes. For example, diphenylsiloxane may be used. Therefore, it will be understood that other materials can be used as well. Silicone oil contains the storage material (Si) and a source of gas on decomposition (CH₃, O). Depending on the processing conditions and process environment (particularly plasma gas composition and processing temperature), the storage material produced can be varied from primarily Si to primarily SiO. Si and SiO can have their own advantages, and varying gas composition and feedstock may allow for varying between the two. By varying the chain length of the polydimethylsiloxane molecule, the viscosity of the resulting oil can be varied over a very wide range, which can be used to tailor the void structure, e.g., a higher viscosity liquid will tend to slow down the rate of bubble coalescence and bursting prior to the completion of the conversion reaction to the storage material, favoring a larger void size and higher porosity. Viscosity can readily be varied between a few centistokes (cS) to hundreds of thousands of cS. In some embodiments, the viscosity would be between 3 and 500 (or about 3 and about 500) cS. In some embodiments, the viscosity can be between 3 and 100 (or about 3 and about 100) cS. In some embodiments, the viscosity can be between 5 and 50 (or about 5 and about 50) Cs. In some embodiments, the viscosity may extend up to 1000 (or about 1000) cS. Under process conditions where the environment is not overly oxidizing, residual carbon can be produced in the structure to improve conductivity and reduce surface reactivity with the electrolyte in the resulting device.

In some embodiments, silicone oil (polydimethylsiloxane) with a viscosity of about 50 cS can be broken up into droplets and fed into a microwave plasma synthesis reactor with an oxygen-based plasma (though other processing methodologies can be used). The droplet size is selected to produce the desired final particle size (for example, 20 um. In some embodiments, the particles can have a range of 0.5-100 um (or about 0.5 to about 100 um). In some embodiments, large particles can be formed, and they may be milled or otherwise reduced in size, such as through ball milling, jet milling, etc. to a final target size. The breakdown of the long chain molecules within the droplet as it passes through the hot zone results in the production of gas (CO₂, H₂O, etc.) which is contained within the droplet as it converts and produces micron to submicron scale voids which become trapped in the structure as it converts to SiO. The result is a micron scale particle with a foam-like structure, where the walls of the bubble “cells” are composed of Si-based storage material (in this case SiO). It will be understood that other methods of forming a voided foam structure can be used as well. As one other example, if a slurry of silicon and/or silicone were reacted with plasma as described above, a foam structure can be formed.

In some embodiments, the plasma reaction environment is more neutral (e.g., argon plasma). This can result in the formation of a Si-dominant structure (rather than SiO in the case of the oxygen rich plasma.)

Similar structures could be obtained for Sn-based alloy storage materials using the related organotin class of materials, e.g., stannoxanes (R₃SnOSnR₃), organotin compounds/stannanes including but not limited to trimethyl-, ethyl-, and tributyltin compounds including oxide, hydride and azide; triethyltin hydroxide, organtin halides, stannoxanes, triphenyltin acetate, triphenyltin hydroxide, fenbutatin oxide, azocyclotin, cyhexatin tin halides including tin chloride, tin fluoride, and organotin halides such as tributyltin chloride, triphenyltin chloride.

In some embodiments, a final size reduction process (e.g. media milling, jet milling, etc.) can be used to achieve the target size distribution. This may or may not be done in conjunction with a size classification step. In some embodiments, a coating step may be used to seal any open porosity, which may create a less reactive surface. For example, a carbon coating can be applied. In some embodiments, an Al₂O₃ coating can be applied.

In some embodiments, the precursor and process conditions can be chosen such that a carbon layer is formed on the surfaces of the alloy-type anode storage material during powder synthesis. In some embodiments, the precursors could be organic or carbon containing compounds, and the conditions in the processing, such as the plasma gas, can be chosen so as to reduce the constituent to carbon, such as by controlling oxygen content. Further, the carbon layer could be formed by introducing a carbon containing additive, such as an organic compound or polymer. This carbon layer can improve conductivity and can help maintain electrical continuity with cycling, as well as reducing reactions with the electrolyte. In some embodiments, this carbon layer can fully encapsulate the external surface of the particle and would not require a separate coating step. In some embodiments, the carbon layer can partially encapsulate the external surface of the particle. In some embodiments, an additional coating step could be used to apply the carbon layer.

### Final Material

In some embodiments, the final material (e.g., post processing) can be a powder that has an internal void structure, or “foam” structure, where the walls of the cells in the foam are composed primarily of energy storage material, for example Si-based anode material. The walls of the cells are from 10's to 100's of nm in the thickness direction, making them tolerant to the large volume change (up to 300% or more, compared to ˜10% for standard graphite-based anodes) that accompany lithiation and delithiation of this class of high energy storage materials. In some embodiments, the walls can be 500 (or about 500) nm or less. In some embodiments, the walls can be less than 200 (or about 200) nm. In some embodiments, the walls can be less than 100 (or about 100) nm. In some embodiments, the walls may be greater than 50 (or about 50) nm. In some embodiments, the walls can range from 50-200 (or about 50-about 200) nm. In some embodiments, the walls can range from 50-150 (or about 50-about 150) nm.

The walls of the cells expand into the available void space upon lithiation and shrink back on delithiation, so that the overall particle size is relatively unchanged when cycled in a device. For example, in some embodiments the volume can change by less than 50%, 25%, 20%, 15%, 10%, 5%, 1%, or 0% (or less than about 50%, about 25%, about 20%, about 15%, about 10%, about 5%, about 1%, or about 0%). This feature can be advantageous to the overall electrochemical cell design, because large volume changes of the anode particle would translate to large electrode coating thickness changes, which was be accounted for in the final electrochemical cell mechanical design as well as the design of the resulting pack, and complicates packaging, thermal management, etc. as well as requiring strain-accommodating features that reduce packaging efficiency and increase device weight. Conventionally processed Si, SiO, Sn, etc. powder without the integral voids and nano-scale structure will undergo rapid mechanical damage and degradation upon cycling, resulting in rapid failure of the storage device. In addition, the powder formed under this disclosure can be utilized in conventional electrochemical cell designs and processed on conventional battery electrode manufacturing equipment, a significant advantage over thin film and vapor deposition approaches to strain tolerant microstructures, which are also cost prohibitive in energy storage applications such as vehicle electrification, grid storage, etc.

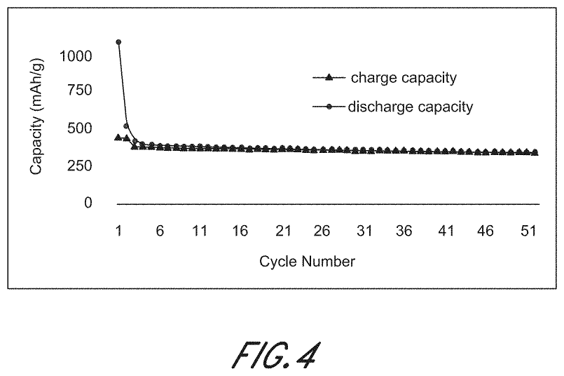

The final material may have the properties discussed above, such as with respect to porosity ranges. FIG. 4 illustrates electrochemical results of a powder of the disclosure.

### Sphericity

In some embodiments, the final particles achieved by processing can be spherical or spheroidal, terms which can be used interchangeably.

Embodiments of the present disclosure are directed to producing particles that are substantially spherical or spheroidal or have undergone significant spheroidization. In some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$$\text{?} = \text{?} \sqrt{\frac{3 V}{4 \text{?}}}$$

$${A}_{s , ideal} = 4 π \text{?}$$

$$\text{?} \text{indicates text missing or illegible when filed}$$

and then comparing that idealized surface area with the measured surface area of the particle, A_{s,actual}:

$$Sphericity = \frac{{A}_{s , ideal}}{{A}_{s , actual}} .$$

In some embodiments, particles can have a sphericity of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

Embodiments of the disclosed process can include feeding the powders using a powder feeder into a microwave generated plasma where the power density, gas flows and residence time are controlled. The process parameters such as power density, flow rates and residence time of the powder in the plasma can depend on the powder material's physical characteristics, such as the melting point and thermal conductivity. The power density can range from 20 W/cm³ to 500 W/cm³ (or about 20 W/cm³ to about 500 W/cm³). The total gas flows can range from 0.1 cfm to 50 cfm (or about 0.1 cfm to about 50 cfm), and the residence time can be tuned from 1 ms to 10 sec (or about 1 ms to about 10 sec). This range of process parameters will cover the required processing parameters for materials with a wide range of melting point and thermal conductivity.

Different environmental gasses can be used for different applications.

### Plasma Processing

The above disclosed particles/structures/powders/precursors can be used in a number of different processing procedures. For example, spray/flame pyrolysis, radiofrequency plasma processing, and high temperature spray driers can all be used. The following disclosure is with respect to microwave plasma processing, but the disclosure is not so limiting.

The precursors disclosed herein can be well stirred and then filtered through a filter membrane, such as with pore sizes from 0.05-0.6 μm, to produce a clean solution free of sediments or insoluble impurities. The resulting solution precursor can be transferred into a vessel where it is fed into a droplet making device that sits on top of a microwave plasma torch. Embodiments of the precursor vessel include a tank, cavity, syringe or hopper beaker. From the precursor vessel, the feedstock can be fed towards a droplet making device. Some embodiments of the droplet making device include a nebulizer and atomizer. The droplet maker can produce solution precursor droplets with diameters ranging approximately 5 um-200 um. The droplets can be fed into the microwave plasma torch, a plasma plume of the microwave plasma torch, and/or an exhaust of the microwave plasma torch. As each droplet is heated within a plasma hot zone created by the microwave plasma torch, the precursor pyrolysis/processing can occur. The plasma gas can be oxygen, argon, nitrogen, helium hydrogen or a mixture thereof.

In some embodiments, the droplet making device can sit to the side of the microwave plasma torch. The feedstock material can be fed by the droplet making device from the side of the microwave plasma torch. The droplets can be fed from any direction into the microwave generated plasma.

Amorphous material can be produced after the precursor is pyrolyzed/processed into the desired material and is then cooled at a rate sufficient to prevent atoms to reach a crystalline state. The cooling rate can be achieved by quenching the material within 0.05-2 seconds of processing in a high velocity gas stream. The high velocity gas stream temperature can be in the range of −200° C.-40° C.

Alternatively, crystalline material can be produced when the plasma length and reactor temperature are sufficient to provide particles with the time and temperature necessary for atoms to diffuse to their thermodynamically favored crystallographic positions. The length of the plasma and reactor temperature can be tuned with parameters such as power (2-120 kW), torch diameter (0.5-4″), reactor length (0.5-30′), gas flow rates (1-20 CFM), gas flow characteristics (laminar or turbulent), and torch type (laminar or turbulent). Longer time at the right temperature results in more crystallinity. As for temperature, it needs to be just right for a given material. Too low temperature would not lead to crystallization (if t<crystallization temperature). Too high temperature would lead to melting or may be even evaporation

The process parameters can be optimized to obtain maximum spheroidization depending on the feedstock initial condition. For each feedstock characteristic, process parameters can be optimized for a particular outcome. U.S. Pat. Pub. No. 2018/0297122, U.S. Pat. No. 8,748,785 B2, and U.S. Pat. No. 9,932,673 B2 disclose certain processing techniques that can be used in the disclosed process, specifically for microwave plasma processing. Accordingly, U.S. Pat. Pub. No. 2018/0297122, U.S. Pat. No. 8,748,785 B2, and U.S. Pat. No. 9,932,673 B2 are incorporated by reference in its entirety and the techniques describes should be considered to be applicable to the feedstock described herein.

One aspect of the present disclosure involves a process of spheroidization using a microwave generated plasma. The powder feedstock is entrained in an inert and/or reducing gas environment and injected into the microwave plasma environment. Upon injection into a hot plasma (or plasma plume or exhaust), the feedstock is spheroidized and released into a chamber filled with an inert gas and directed into hermetically sealed drums where is it stored. This process can be carried out at atmospheric pressure, in a partial vacuum, or at a slightly higher pressure than atmospheric pressure. In alternative embodiments, the process can be carried out in a low, medium, or high vacuum environment. The process can run continuously and the drums are replaced as they fill up with spheroidized particles.

Cooling processing parameters include, but are not limited to, cooling gas flow rate, residence time of the spheroidized particles in the hot zone, and the composition or make of the cooling gas. For example, the cooling rate or quenching rate of the particles can be increased by increasing the rate of flow of the cooling gas. The faster the cooling gas is flowed past the spheroidized particles exiting the plasma, the higher the quenching rate-thereby allowing certain desired microstructures to be locked-in. Residence time of the particles within the hot zone of the plasma can also be adjusted to provide control over the resulting microstructure. That is, the length of time the particles are exposed to the plasma determines the extent of melting of the particle (i.e., surface of the particle melted as compared to the inner most portion or core of the particle). Consequently, the extent of melting effects the extent of cooling needed for solidification and thus it is a cooling process parameter. Microstructural changes can be incorporated throughout the entire particle or just a portion thereof depending upon the extent of particle melting. Residence time can be adjusted by adjusting such operating variables of particle injection rate and flow rate (and conditions, such as laminar flow or turbulent flow) within the hot zone. Equipment changes can also be used to adjust residence time. For example, residence time can be adjusted by changing the cross-sectional area of the hot zone.

Another cooling processing parameter that can be varied or controlled is the composition of the cooling gas. Certain cooling gases are more thermally conductive than others. For example helium is considered to be a highly thermally conductive gas. The higher the thermal conductivity of the cooling gas, the faster the spheroidized particles can be cooled/quenched. By controlling the composition of the cooling gas (e.g., controlling the quantity or ratio of high thermally conductive gasses to lesser thermally conductive gases) the cooling rate can be controlled.

In one exemplary embodiment, inert gas is continually purged to remove oxygen within a powder-feed hopper. A continuous volume of powder feed is then entrained within an inert gas and fed into the microwave generated plasma for dehydrogenation or for composition/maintaining purity of the spheroidized particles. In one example, the microwave generated plasma may be generated using a microwave plasma torch, as described in U.S. Patent Publication No. US 2013/0270261, and/or U.S. Pat. Nos. 8,748,785, 9,023,259, 9,259,785, and 9,206,085, each of which is hereby incorporated by reference in its entirety. In some embodiments, the particles are exposed to a uniform (or non-uniform) temperature profile at between 4,000 and 8,000 K within the microwave generated plasma. In some embodiments, the particles are exposed to a uniform temperature profile at between 3,000 and 8,000 K within the microwave generated plasma. Within the plasma torch, the powder particles are rapidly heated and melted. As the particles within the process are entrained within an inert gas, such as argon, generally contact between particles is minimal, greatly reducing the occurrence of particle agglomeration. The need for post-process sifting is thus greatly reduced or eliminated, and the resulting particle size distribution could be practically the same as the particle size distribution of the input feed materials. In exemplary embodiments, the particle size distribution of the feed materials is maintained in the end products.

Within the plasma, plasma plume, or exhaust, the melted materials are inherently spheroidized due to liquid surface tension. As the microwave generated plasma exhibits a substantially uniform temperature profile, more than 90% spheroidization of particles could be achieved (e.g., 91%, 93%, 95%, 97%, 99%, 100%). After exiting the plasma, the particles are cooled before entering collection bins. When the collection bins fill, they can be removed and replaced with an empty bin as needed without stopping the process.

In one exemplary embodiment, inert gas is continually purged surrounding a powdered feed to remove oxygen within a powder-feed hopper. A continuous volume of powder feed is then entrained within an inert gas and fed into the microwave generated plasma for composition/maintaining purity of the spheroidized particles. In one example, the microwave generated plasma may be generated using a microwave plasma torch, as described in U.S. Patent Publication No. US 2013/0270261, and/or U.S. Pat. No. 8,748,785, each of which is hereby incorporated by reference in its entirety. In some embodiments, the particles are exposed to a uniform temperature profile at between 4,000 and 8,000 K within the microwave generated plasma. Within the plasma torch, the powder particles are rapidly heated and melted. As the particles within the process are entrained within an inert gas, such as argon, generally contact between particles is minimal, greatly reducing the occurrence of particle agglomeration. The need for post-process sifting is thus greatly reduced or eliminated, and the resulting particle size distribution could be practically the same as the particle size distribution of the input feed materials. In exemplary embodiments, the particle size distribution of the feed materials is maintained in the end products.

Within the plasma, the melted materials are inherently spheroidized due to liquid surface tension. As the microwave generated plasma exhibits a substantially uniform temperature profile, more than 90% spheroidization of particles could be achieved (e.g., 91%, 93%, 95%, 97%, 99%, 100%). In embodiments, both spheroidization and tailoring (e.g., changing, manipulating, controlling) microstructure are addressed or, in some instances, partially controlled, by treating with the microwave generated plasma. After exiting the plasma, the particles are cooled before entering collection bins. When the collection bins fill, they can be removed and replaced with an empty bin as needed without stopping the process.

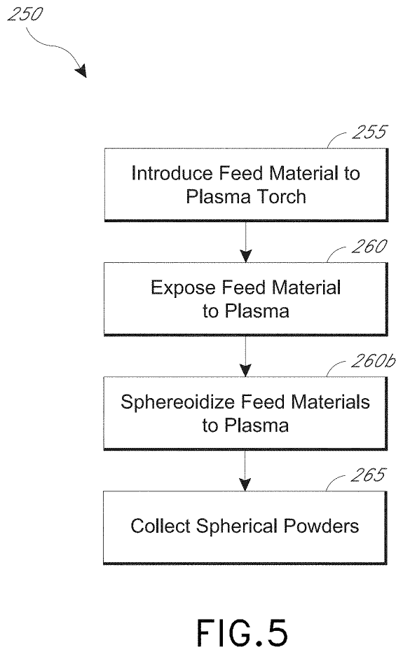

FIG. 5 is a flow chart illustrating an exemplary method (250) for producing spherical powders, according to an embodiment of the present disclosure. In this embodiment, the process (250) begins by introducing a feed material into a plasma torch (255). In some embodiments, the plasma torch is a microwave generated plasma torch or an RF plasma torch. Within the plasma torch, the feed materials are exposed to a plasma causing the materials to melt, as described above (260). The melted materials are spheroidized by surface tension, as discussed above (260b). After exiting the plasma, the products cool and solidify, locking in the spherical shape and are then collected (265).

As discussed above, the plasma torch can be a microwave generated plasma or an RF plasma torch. In one example embodiment, an AT-1200 rotating powder feeder (available from Thermach Inc.) allows a good control of the feed rate of the powder. In an alternative embodiment, the powder can be fed into the plasma using other suitable means, such as a fluidized bed feeder. The feed materials may be introduced at a constant rate, and the rate may be adjusted such that particles do not agglomerate during subsequent processing steps. In another exemplary embodiment, the feed materials to be processed are first sifted and classified according to their diameters, with a minimum diameter of 1 micrometers (μm) and a maximum diameter of 22 μm, or a minimum of 5 μm and a maximum of 15 μm, or a minimum of 15 μm and a maximum of 45 μm or a minimum of 22 μm and a maximum of 44 μm, or a minimum of 20 μm to a maximum of 63 μm, or a minimum of 44 μm and a maximum of 70 μm, or a minimum of 70 μm and a maximum of 106 μm, or a minimum of 105 μm to a maximum of 150 μm, or a minimum of 106 μm and a maximum of 300 μm. As will be appreciated, these upper and lower values are provided for illustrative purposes only, and alternative size distribution values may be used in other embodiments. This eliminates recirculation of light particles above the hot zone of the plasma and also ensures that the process energy present in the plasma is sufficient to melt the particles without vaporization. Pre-screening allows efficient allocation of microwave power necessary to melt the particles without vaporizing material.

In some embodiments, the environment and/or sealing requirements of the bins are carefully controlled. That is, to prevent contamination or potential oxidation of the powders, the environment and or seals of the bins are tailored to the application. In one embodiment, the bins are under a vacuum. In one embodiment, the bins are hermetically sealed after being filled with powder generated in accordance with the present technology. In one embodiment, the bins are back filled with an inert gas, such as, for example argon. Because of the continuous nature of the process, once a bin is filled, it can be removed and replaced with an empty bin as needed without stopping the plasma process.

The methods and processes in accordance with the disclosure can be used to make powders, such as spherical powders.

In some embodiments, the processing discussed herein, such as the microwave plasma processing, can be controlled to prevent and/or minimize certain elements for escaping the feedstock during the melt, which can maintain the desired composition/microstructure.

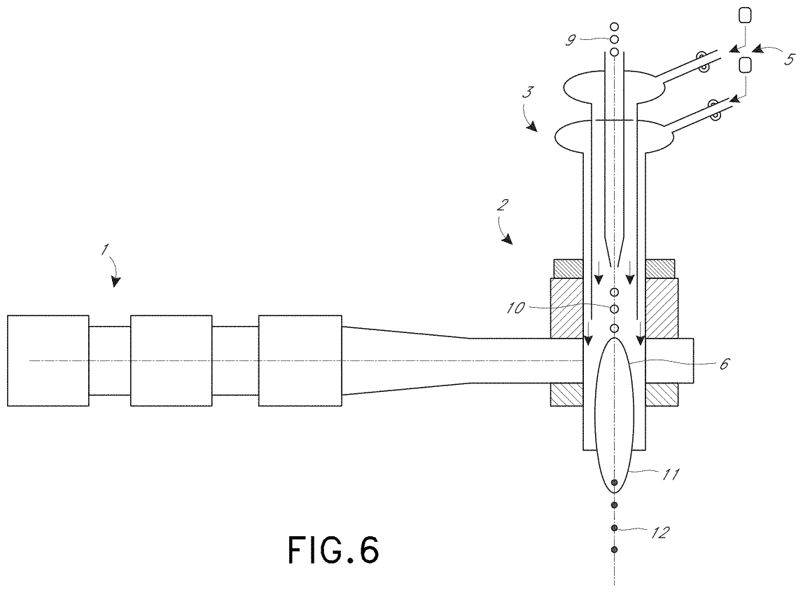

FIG. 6 illustrates an exemplary microwave plasma torch that can be used in the production of powders, according to embodiments of the present disclosure. As discussed above, feed materials 9, 10 can be introduced into a microwave plasma torch 3, which sustains a microwave generated plasma 11. In one example embodiment, an entrainment gas flow and a sheath flow (downward arrows) may be injected through inlets 5 to create flow conditions within the plasma torch prior to ignition of the plasma 11 via microwave radiation source 1. In some embodiments, the entrainment flow and sheath flow are both axis-symmetric and laminar, while in other embodiments the gas flows are swirling. The feed materials 9 are introduced axially into the microwave plasma torch, where they are entrained by a gas flow that directs the materials toward the plasma. As discussed above, the gas flows can consist of a noble gas column of the periodic table, such as helium, neon, argon, etc. Within the microwave generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch 3 to protect it from melting due to heat radiation from plasma 11. In exemplary embodiments, the laminar flows direct particles 9, 10 toward the plasma 11 along a path as close as possible to axis 12, exposing them to a substantially uniform temperature within the plasma. In some embodiments, suitable flow conditions are present to keep particles 10 from reaching the inner wall of the plasma torch 3 where plasma attachment could take place. Particles 9, 10 are guided by the gas flows towards microwave plasma 11 were each undergoes homogeneous thermal treatment. Various parameters of the microwave generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting plasma 11. As discussed above, in this particular embodiment, the gas flows are laminar; however, in alternative embodiments, swirl flows or turbulent flows may be used to direct the feed materials toward the plasma.

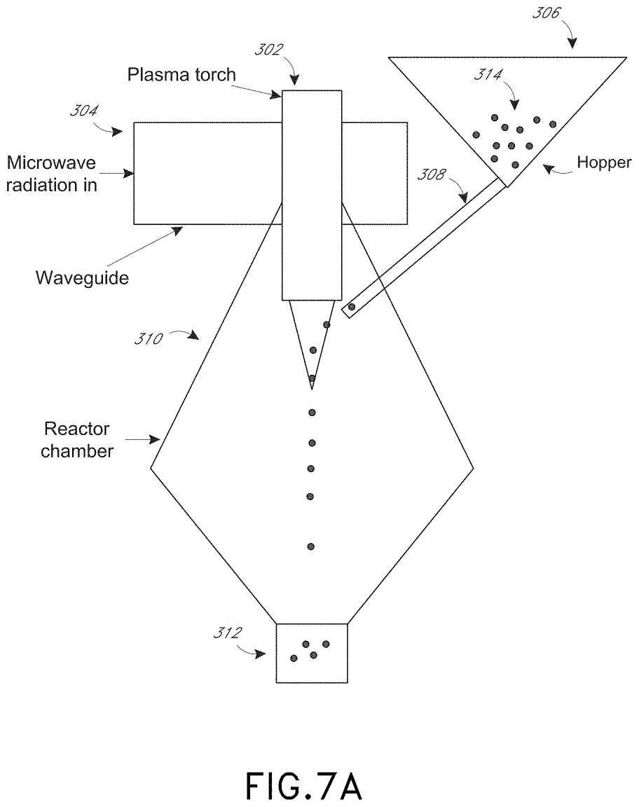

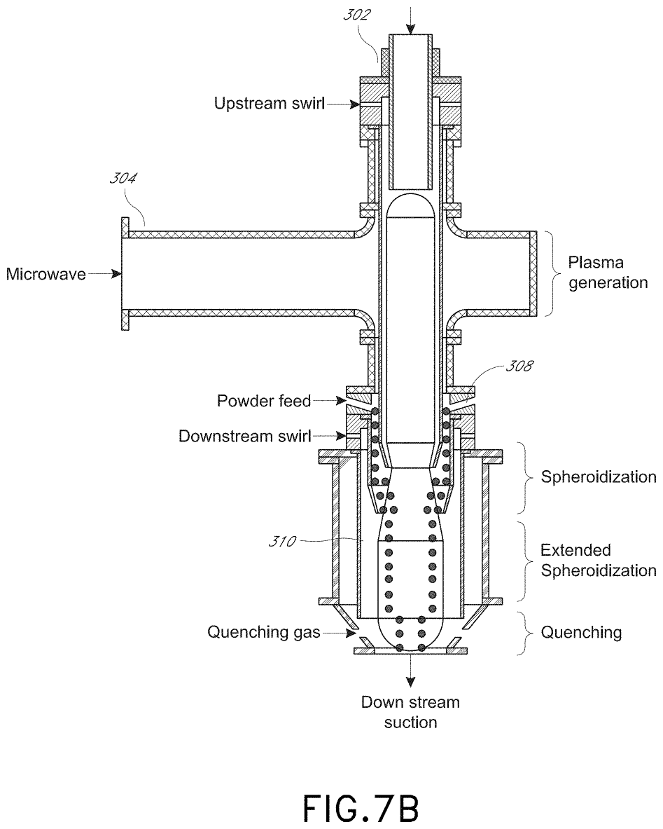

FIGS. 7A-B illustrates an exemplary microwave plasma torch that includes a side feeding hopper rather than the top feeding hopper shown in the embodiment of FIG. 6, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 6. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. No. 8,748,785 B2 and U.S. Pat. No. 9,932,673 B2. Both FIG. 7A and FIG. 7B show embodiments of a method that can be implemented with either an annular torch or a swirl torch. A feed system close-coupled with the plasma plume at the exit of the plasma torch is used to feed powder axisymmetrically to preserve process homogeneity. Other feeding configurations may include one or several individual feeding nozzles surrounding the plasma plume. The feedstock powder can enter the plasma from any direction and can be fed in 360° around the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 314 can be introduced into a microwave plasma torch 302. A hopper 306 can be used to store the feed material 314 before feeding the feed material 314 into the microwave plasma torch 302, plume, or exhaust. The feed material 314 can be injected at any angle to the longitudinal direction of the plasma torch 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch. The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase and cool and solidify outside the plasma chamber. In some embodiments, a quenching chamber may be used, which may or may not use positive pressure. While described separately from FIG. 6, the embodiments of FIGS. 7A-7B are understood to use similar features and conditions to the embodiment of FIG. 6.

In some embodiments, implementation of the downstream injection method may use a downstream swirl, extended spheroidization, or quenching. A downstream swirl refers to an additional swirl component that can be introduced downstream from the plasma torch to keep the powder from the walls of the tube. An extended spheroidization refers to an extended plasma chamber to give the powder longer residence time. In some implementations, it may not use a downstream swirl, extended spheroidization, or quenching. In some embodiments, it may use one of a downstream swirl, extended spheroidization, or quenching. In some embodiments, it may use two of a downstream swirl, extended spheroidization, or quenching.

Injection of powder from below may results in the reduction or elimination of plasma-tube coating in the microwave region. When the coating becomes too substantial, the microwave energy is shielded from entering the plasma hot zone and the plasma coupling is reduced. At times, the plasma may even extinguish and become unstable. Decrease of plasma intensity means decreases in spheroidization level of the powder. Thus, by feeding feedstock below the microwave region and engaging the plasma plume at the exit of the plasma torch, coating in this region is eliminated and the microwave powder to plasma coupling remains constant through the process allowing adequate spheroidization.

Thus, advantageously the downstream approach may allow for the method to run for long durations as the coating issue is reduced. Further, the downstream approach allows for the ability to inject more powder as there is no need to minimize coating.

From the foregoing description, it will be appreciated that inventive processing methods, precursors, anodes, and powders are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A strain tolerant particle comprising:
a plurality of walls surrounding a plurality of voids, the walls being between 10-90% of a total volume of the particle; and
Si, Si monoxide, Sn, or Sn oxide;
wherein the particle is configured to stay within 50 volume % during lithiation and delithiation.

2. The particle of claim 1, wherein the plurality of voids are closed cells.

3. The particle of claim 1, wherein the plurality of voids are open cells.

4. The particle of claim 1, wherein the plurality of voids are a mixture of closed cells and open cells.

5. The particle of claim 1, wherein the plurality of walls are between 20 and 50% of the total volume of the particle.

6. The particle of claim 1, wherein the plurality of walls have a thickness of between 50 and 150 nm.

7. The particle of claim 1, wherein the particle is coated with carbon.

8. The particle of claim 1, wherein the particle is configured to stay within 10 volume % during lithiation and delithiation.

9. The particle of claim 1, wherein the particle further comprises a transition metal.

10. The particle of claim 1, wherein the particle comprises polydimethylsiloxane.

11. The particle of claim 1, wherein the particle comprises diphenylsiloxane.

12. A powder formed from a plurality of the particle of claim 1.

13. The powder of claim 12, wherein a D50 of the powder lies between 0.2 and 100 um.

14. An anode formed from the particle of claim 1.

15. A battery formed from the anode of claim 14.

16. A method of manufacturing a strain tolerant powder, the method comprising:
preparing a precursor material including an Si, Si monoxide, Sn, or Sn oxide material and a component that produces gas;
forming droplets from the precursor material; and
interacting the droplets in a plasma or plasma exhaust of a microwave plasma torch to produce gases from the component and form a powder of a plurality of particles;
wherein the precursor material is configured to prevent gas bubbles formed during synthesis from coalescing and/or escaping; and
wherein the particles in the powder are configured to stay within 50 volume % during lithiation and delithiation.

17. The method of claim 16, wherein a viscosity of the precursor material is between 3 and 500 cS.

18. The method of claim 16, wherein the plurality of particles includes a carbon coating.

19. The method of claim 16, wherein the plurality of particles includes an Al₂O₃ coating.

20. A strain tolerant particle comprising:
a composition comprising:
silicon, tin, or a combination of silicon and tin;
a transition metal; and
silica; and
a plurality of walls surrounding a plurality of voids, the walls being between 10-90% of a total volume of the particle;
wherein the particle is configured to stay within 50 volume % during lithiation and delithiation.
